(19) United States
(12) Patent Application Publication
(10) Pub. No.: US 2016/0189153 A1
(43) Pub. Date: Jun. 30, 2016

(54) SYSTEMS AND METHODS FOR ONLINE ACTIVITY-BASED AUTHENTICATION

(71) Applicant: EBAY INC., San Jose, CA (US)

(72) Inventors: Bryant Genepang Luk, Round Rock, TX (US); Yu Tang, Round Rock, TX (US); Jennifer Brenner, Austin, TX (US); Christopher Diebold O'Toole, Cedar Park, TX (US); Richard Chapman Bates, Austin, TX (US); Jason Ziaja, Cedar Park, TX (US); Ananya Das, Austin, TX (US)

(21) Appl. No.: 14/586,874

(22) Filed: Dec. 30, 2014

(51) Int. Cl. G06Q 20/40; G06Q 50/00

(52) U.S. Cl. CPC G06Q 20/405; G06Q 20/4014; G06Q 50/01

(57) ABSTRACT

Systems and methods for authentication of users using online activity are provided. An authentication system may build a user profile in a database by associating online activity data with a user in the user profile, and further by processing the online activity data to generate user interest data and associating it with the user. The authentication system may receive a payment request for a purchase of an item using a payment account of the user. The authentication system may determine if the purchase of the item by the user is consistent with the user's online activity data and/or user interest data. If consistent, the authentication system may authenticate the user and process the payment request by approving the payment request.

### BACKGROUND

1. Field of the Invention

The present invention generally relates to authentication and, more particularly, to authentication using online activity.

2. Related Art

Many users make purchases online on websites that offer products and services for purchase. A user may provide a service provider with payment information for a payment account, and the service provider may store the payment information so that the user may use the payment account to make a purchase. At a later time, the user may enter credentials (e.g., a user identifier (ID) and a password) on a website to login to an account with the service provider and make a purchase using the payment account without reentering in the payment information. However, as a result of identity theft, an unauthorized user may login to the account of the user and make unauthorized purchases using the payment account.

### BRIEF DESCRIPTION OF THE FIGURES

FIG. 1 is a block diagram illustrating an exemplary networked system for authentication using online activity according to an embodiment of the present disclosure;

FIG. 2 is a block diagram for an exemplary user profile database according to an embodiment of the present disclosure;

FIG. 3 is a flowchart showing an illustrative method for authentication using online activity according to an embodiment of the present disclosure;

FIG. 4 is a flowchart showing an illustrative method for method for authentication using a user profile according to an embodiment of the present disclosure; and

FIG. 5 is a block diagram of a system for implementing one or more components in FIG. 1 according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for authentication using online activity.

In various embodiments, a user who is interested in purchasing an item may use a user device to view a website containing an online representation of the item (e.g., an image of the item, a written description of the item, a model number of the item, a video of the item, etc.). The user may view online representations of the item (or items having an item type of the item) on one or more websites several times before purchasing the item. For example, the user may view images of the item, read descriptions or customer reviews of the item, click on images of the item or links relating to the item (e.g., link to a product page of the item), and/or enter search terms relating to the item (e.g., to compare prices of the item at various merchant sites) while the user considers buying the item and compares the item with similar items.

The user may have an account with a service provider, and account information for a payment account may be stored on a service provider server associated with the service provider. The user may add the item to a cart on a website of a merchant to purchase the item using the payment account. A merchant server associated with the merchant may send a payment request for the purchase to the service provider server. An authentication system, which may be implemented on service provider server, may authenticate the user using one or more authentication techniques before approving the payment request.

In various embodiments, the service provider server may authenticate the user based, at least in part, on online activity of the user and/or interests of the user. Online activity may include viewed online representations of items, browsing history, clicked-on links, entered search terms, and other browsing activity. The service provider server may receive data relating to the user's online activity from the user device. Online activity may further include mentioning or discussing items on social media posts (e.g., social networking site (SNS) posts) and/or emails. The service provider server may obtain data relating to social media posts and/or emails by scraping a social media account (e.g., an SNS account) and/or email account of the user. The service provider server may store browsing activity data, social media post data, and/or email data in a database to build a user profile. The service provider server may process the online activity data to generate user interest data indicating interests of the user and store the user interest data in the database to further build the user profile.

In response to receiving the payment request for the purchase of the item, the service provider server may determine whether the purchase of the item by the user is consistent with the online activity data and/or user interest data, and authenticate the user. For example, if the online activity data indicates that the user viewed images and descriptions of the item multiple times, clicked on links relating to the item, and/or entered search terms relating to the item, the service provider server may determine that the user is who the user claims to be (e.g., the user making the purchase is the user associated with the payment account), and authenticate the user. The service provider server may process the payment request in response to authenticating the user.

In various embodiments, a user (e.g., a child) may have an account with a service provider, and account information for a payment account of another user associated with the user (e.g., a parent of the child) may be stored on a service provider server associated with the service provider. The user may add an item to a cart on a website of a merchant to purchase the item using the payment account. A merchant server associated with the merchant' may send a payment request for the purchase to the service provider server. The service provider server may determine that the other user (e.g., the parent) authorized the user (e.g., the child) to make the purchase by determining whether the purchase of the item by the user (e.g., the child) is consistent with online activity data of the other user (e.g., the parent).

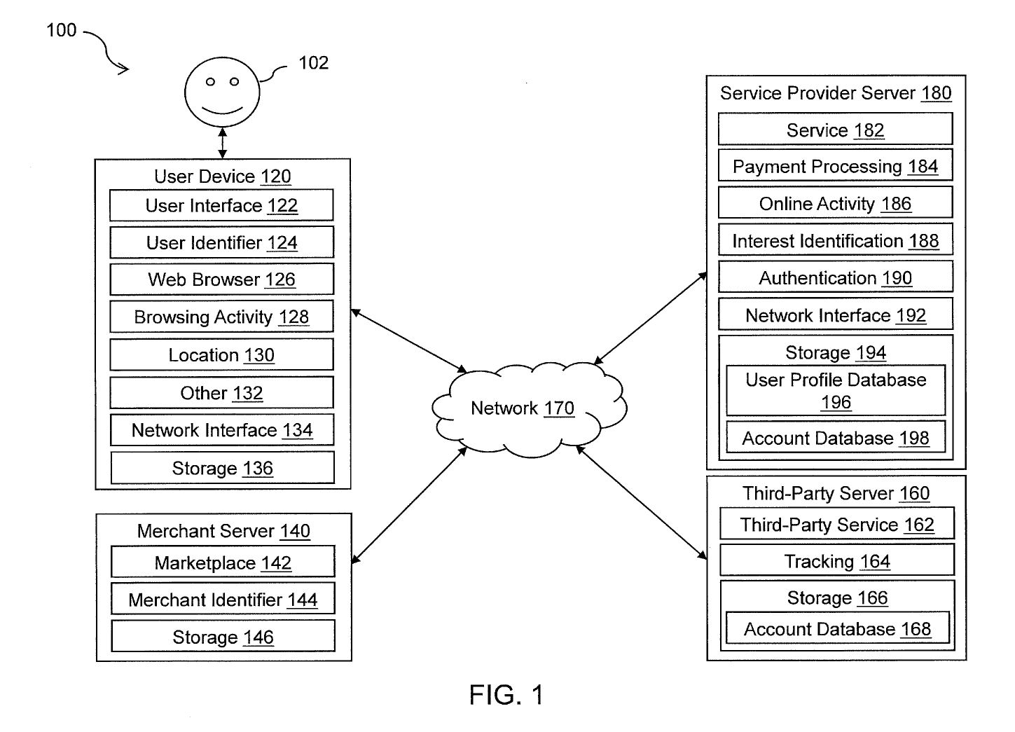

Referring now to FIG.1, an exemplary network-based system 100 for implementing authentication using online activity is illustrated according to an embodiment of the present disclosure. As shown, network-based system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of networked system 100 illustrated in FIG. 1 includes one or more user devices 120 (e.g., a mobile phone, a smartphone, a wearable device, a desktop personal computer, etc.) of one or more respective users 102, one or more merchant servers 140, one or more third-party servers 160, and/or one or more service provider servers 180 (e.g., network server devices) in communication over network 170. Network 170, in one embodiment, may be implemented as a single network or a combination of multiple networks. For example, in various embodiments, network 170 may include the Internet and/or one or more intranets, landline networks, wireless networks, and/or other appropriate types of communication networks. In another example, network 170 may comprise a wireless telecommunications network (e.g., cellular phone network) adapted to communicate with other communication networks, such as the Internet. As such, in various embodiments, user device 120, merchant server 140, Third-party server 160, and/or service provider server 180 may be associated with a particular link (e.g., a link, such as a URL (Uniform Resource Locator) to an IP (Internet Protocol) address).

User device 120, in various embodiments, may be utilized by user 102 to interact with merchant server 140, third-party server 160, and/or service provider server 180 over network 170. User device 120 may be implemented using any appropriate combination of hardware and/or software configured for wired and/or wireless communication over network 170. In various embodiments, user devices 120 may include at least one of a smartphone, wireless cellular phone, satellite phone, tablet, laptop computer, notebook computer, hybrid/convertible computer, a desktop personal computer, a gaming device (e.g., a video game console), and/or other types of computing devices. In other embodiments, user devices 120 may include at least one of a wearable device, such as an activity tracker (e.g., a fitness tracker, a health tracker, etc.), smart watch, eyeglasses with appropriate computer hardware resources, and/or other types of wearable computing devices. User devices 120 may include a user interface module 122, one or more user identifiers 124, a web browser module 126, a browsing activity module 128, a location module 130, other modules 132, a network interface module 134, and a storage module 136.

In various implementations, user 102 is able to input data and information into an input component (e.g., a touchscreen, a keyboard, a microphone, a video game console controller, etc.) of user device 120 to provide personal information, user interest information, user identification information, and other user data and/or information.

User interface module 122, in an embodiment, may be utilized by user 102 to access applications, to view data or information on a display of user device 120, and to conduct transactions (e.g., shopping, purchasing, bidding, etc.) with merchant server 140, third-party server 160 and/or service provider server 180 over network 170. In one aspect, user 102 may login to an account associated with user 102, and purchase expenses may be directly and/or automatically debited from the account via user interface module 122.

In one implementation, user interface module 122 includes a software program, such as a graphical user interface (GUI), executable by a processor that is configured to interface and communicate with third-party server 160 and/or service provider server 180 via network 170.

One or more user identifiers 124, in an embodiment, may be implemented as operating system registry entries, cookies associated with user interface module 122, identifiers associated with hardware of user device 120, or various other appropriate identifiers. User identifier 124 may include one or more attributes related to user 102, such as personal information related to user 102 (e.g., one or more of names, user names, passwords, photograph images, biometric IDs, addresses, phone numbers, a social security number, etc.), banking information, financial information, and/or funding source information (e.g., one or more banking institutions, credit card issuers, user account numbers, security data and information, etc.). In various embodiments, credentials that include user identifier 124 may be transmitted with a user login request to third-party server 160 or service provider server 180 via network 170. Third-party server 160 or service provider server 180 may use the credentials to associate user 102 with a particular user account maintained by third-party server 160 or service provider server 180.

Web browser module 126, in an embodiment, may be utilized by user 102 to browse information available over network 170. In various embodiments, web browser module 126 may be configured to provide access to email accounts and social media accounts maintained by one or more third-party server 160. User 102 may use web browser module 126 to view email and access social media sites via one or more third-party servers 160.

In other embodiments, web browser module 126 may be configured to provide access to merchant websites via one or more merchant servers 140. User 102 may use web browser module 126 to view and select items for purchase, and user 102 may purchase items from one or more merchant servers 140 via service provider server 180. Accordingly, user 102 may conduct transactions (e.g., purchase and provide payment for one or more items) from one or more merchant servers 140 via service provider server 180.

Browsing activity module 128, in an embodiment, is configured to capture online activity of user 102. Browsing activity module 128 may be a part of the web browser module 126 or may be provided as a separate module in user device 120. Browsing activity module 128 may capture browsing activity, including browsing history (e.g., a list of visited webpages, page titles of each visited webpage, and a time of visit for each webpage, etc.), viewed items (e.g., representation of items presented on webpages), clicked-on links, search terms entered, and/or other browsing activity, as browsing activity data. Browsing activity data may include an association between each browsing activity and a time when it occurred. Browsing activity module 128 may record and track the browsing activity by storing the browsing activity data in storage module 136. Browsing activity module 128 may transmit and/or sync the browsing activity data to online activity module 186 of service provider server 180 via network 170.

Location module 130, in an embodiment, determines, tracks, monitors, and/or provides an instant geographical location of user device 120. In one implementation, the geographical location may include GPS coordinates, zip-code information, area-code information, street address information, and/or various other generally known types of location data or information. In various embodiments, location data may be automatically obtained and/or provided by user device 150 via an internal or external monitoring component, such as global positioning system (GPS), which uses satellite-based positioning, assisted GPS (A-GPS), which uses cell tower information to improve reliability and accuracy of GPS-based positioning, and Wi-Fi-based positioning. In other embodiments, location data may be obtained based on communications between user device 150 and a device at a location, such as a check-in device (e.g., a beacon device). This may help to save battery life and allow for better indoor location. In further embodiments, location information may be directly entered into user device 120 by user 102 via a user input component, such as a keyboard, touch display, and/or voice recognition microphone.

User device 120, in an embodiment, may include other modules 132 as may be desired in one or more embodiments of the present disclosure to provide additional features available to user 102. In one example, other modules 132 may include security modules for implementing client-side security features, programmatic client applications for interfacing with appropriate application programming interfaces (APIs) over network 170, and/or various other types of generally known programs and/or software modules. In still other examples, the other modules may interface with user interface module 122 for improved efficiency and convenience.

Network interface module 134, in an embodiment, communicates with other devices or servers over network 170. For example, user device 120 may communicate with merchant server 140, third-party server 160, and/or service provider server 180 via network interface module 134 exchanging data and/or information (e.g., data packets) with a network interface module of respective devices or servers over network 170.

Storage module 136, in an embodiment, may store data and information. Storage module 136 may contain one or more databases in which to store the data and information. User device 120 may locally store user account information and/or browsing activity data in a database on storage module 136.

In one aspect, when interfacing with user device 120, user 102 may elect and/or consent to provide browsing activity data, personal information, user interest data, location data, and/or other user data or information to merchant server 140, third-party server 160, and/or service provider server 180. User 102 may set or configure the user settings/configuration menu of user interface module 122 of user device 120. Through the user settings/configuration menu, user 102 may provide consent to share user data or information and the extent of shared user data or information. User device 120 may transmit shared user data or information dynamically by push synchronization, periodically, or each time an application associated with merchant server 140, third-party server 160, and/or service provider server 180 is opened by user 102. In some embodiments, user 102 may be prompted for permission to release user data or information. Accordingly, user 102 may have exclusive authority to allow transmission of browsing activity data, personal information, user interest data, and/or location data from user device 120 to merchant server 140, third-party server 160, and/or service provider server 180.

One or more merchant servers 140, in various embodiments, may be maintained by one or more business entities that offer various items, such as goods and/or services, for purchase and payment (e.g., an online retailer, a discount retailer, a supermarket, a grocery store, a convenience store, a farmers market, a restaurant, a café, a merchandise store, a clothing store, a department store, an electronics store, or other merchant) or, in some cases, by a partner of a business entity that processes transactions on behalf of business entities. The business entities may maintain a merchant website through which the various items are offered for purchase and payment. In some embodiments, business entities may need registration of user identification information as part of offering items to user 102 over network 170. As such, each of one or more merchant servers 140 may include a merchant database on a storage module 146 for identifying available items, which may be made available, at least in part, to user device 120 for viewing and purchase by user 102. In one or more embodiments, user 102 may complete a transaction such as purchasing the items via service provider server 180.

Each of merchant servers 140, in one embodiment, may include a marketplace module 142, which may be configured to provide data or information to user device 120 over network 170. For example, marketplace module 144 may transmit item data or information to user device 120 to present the item data or information on user device 120. User 102 may interact with marketplace module 144 through user interface module 122 and/or web browser module 126 of user device 120 to search and view various items available for purchase in the merchant database on storage module 146.

Each of merchant servers 140, in one embodiment, may include at least one merchant identifier 144, which may be included as part of the one or more items made available for purchase so that, for example, particular items are associated with particular merchants. In one implementation, merchant identifier 144 may include one or more attributes and/or parameters related to the merchant, such as business and banking information. Merchant identifier 144 may include attributes related to merchant server 140, such as identification information (e.g., a serial number, a location address, GPS coordinates, a network identification number, etc.). In various embodiments, user 102 may conduct transactions (e.g., searching, selection, monitoring, purchasing, and/or providing payment for items) with each merchant server 140 via service provider server 180 over network 170.

A merchant website, in an embodiment, may be maintained by a merchant and communicate (e.g., using merchant server 140) with service provider server 180 over network 170. For example, the merchant website may communicate with service provider server 180 in the course of various services offered by service provider server 180 to the merchant website, such as payment intermediary between customers of the merchant website and the merchant. The merchant website may use an application programming interface (API) that allows it to offer sale of goods in which customers are allowed to make payment through service provider server 180, while user 102 may have an account with service provider server 180 that allows user 102 to use service provider server 180 for making payments to merchants that allow use of authentication, authorization, and payment services of service provider server 180 as a payment intermediary. The merchant website may also have an account with service provider server 180.

One or more third-party servers 160, in an embodiment, may be maintained by one or more business entities that offer various online services, and may host the online services. Third-party server 160 may include a third-party service module 162 configured to provide online services and a storage module 166 storing an account database 168. In various implementations, third-party server 160 and/or third-party service module 162 may host a website associated with or employed by a third party. For example, third-party server 160 and/or third-party service module 162 may enable system 100 to provide user 102 with email services and/or information, social media services and/or information, or other online services and/or information.

In one embodiment, third-party server 160 may include a social media server that hosts one or more social media accounts (e.g., a social media account for user 102 of user device 120). User 102 may use user interface module 122 and/or web browser module 126 of user device 120 to access a social media account of user 102 on a social media site that is hosted by one of third-party servers 160. Third-party server 160 may store the one or more social media accounts in account database 168 on storage module 166.

In another embodiment, third party server 160 may include an email server that hosts email services (e.g., an email account for user 102). User 102 may use user interface module 122 and/or web browser module 126 of user device 120 to send, store, and receive emails or other electronic communications on an email account of user 102 that is hosted by one of third-party server 160. Third-party server 160 may store the one or more email accounts in account database 168 on storage module 166.

In a further embodiment, third-party server 160 may include an online activity tracking server (e.g., an advertising server) that includes a tracking module 164. Tracking module 164 may track online activity of user 102 using tracking cookies to record and track browsing activity of user 102. For example, when user 102 uses user device 120 to visit a website affiliated with the tracking server, the website may send one or more cookies to web browser module 126 of user device 120. Then, when user 102 uses user device 120 to visit websites affiliated with the tracking server, web browser module 126 may send the one or more cookies to third-party server 160 to notify third-party server 160 of browsing activity of user 102. Third-party server 160 may store the browsing activity data (e.g., as server logs) that includes the one or more cookies that identify web browser module 126, web requests of user 102 (e.g., searches performed by user 102, clicked-on links by user 102, etc.), time of the web requests, an IP address, the type of web browser module 126, and/or language used by web browser module 126.

Service provider server 180, in one embodiment, may be maintained by a service provider, such as an online service provider or a transaction processing entity that provides processing for financial transactions and/or information transactions between user 102 and one or more of merchant servers 140. Service provider server 180 may include a service module 182, a payment processing module 184, an online activity module 186, an interest identification module 188, an authentication module 190, a network interface module 192, and/or a storage module 194. Any or all of the modules may be implemented as a subsystem of service provider server 180 including a circuit, a hardware component, a hardware subcomponent, and/or a variety of other subsystems known in the art. Furthermore, any or all of the modules may be preconfigured to perform their disclosed functionality, or may be configured by a processing system “on-the-fly” or as needed to perform their disclosed functionality. As such, any or all of the modules may include pre-configured and dedicated circuits and/or hardware components, or may be circuits and/or hardware components that are configured as needed.

For example, any or all of the modules may be provided via one or more circuits that include resistors, inductors, capacitors, voltage sources, current sources, switches, logic gates, registers, and/or a variety of other circuit elements known in the art. One or more of the circuit elements in a circuit may be configured to provide the circuit(s) that cause the modules to perform the functions described below. As such, in some embodiments, preconfigured and dedicated circuits may be implemented to perform the functions of the modules. In other embodiments, a processing system may execute instructions on a non-transitory, computer-readable medium to configure one or more circuits as needed to perform the functions of the modules.

Service module 182 may be included as a separate module provided in service provider server 180, or may be provided using instructions stored on a computer-readable medium that, when executed by a processing system in service provider server 180, configure service module 182 to interact with the user device 120 over network 170 to facilitate the searching, selection, purchase, and/or payment of items by user 102 from one or more merchant servers 140, as well as well as provide any of the other functionality that is discussed herein. Payment processing module 184 may be included as a separate module provided in service provider server 180, or may be provided using instructions stored on a computer-readable medium that, when executed by a processing system in service provider server 180, configure payment processing module 184 to process purchases and/or payments for financial transactions between user 102 and each of merchant servers 140, as well as well as provide any of the other functionality that is discussed herein. In one implementation, payment processing module 184 assists with resolving financial transactions through validation, delivery, and settlement. As such, service module 182 in conjunction with the payment processing module 184 settles indebtedness between user 102 and each of merchant servers 140, wherein accounts may be directly and/or automatically debited and/or credited of monetary funds in a manner as accepted by the banking industry.

Online activity module 186 may be included as a separate module provided in service provider server 180, or may be provided using instructions stored on a computer-readable medium that, when executed by a processing system in service provider server 180, configure online activity module 186 to associate online activity data with user 102 in user profile database 196 in storage module 194 in response to receiving the online activity data, as well as provide any of the other functionality that is discussed herein. Interest identification module 188 may be included as a separate module provided in service provider server 180, or may be provided using instructions stored on a computer-readable medium that, when executed by a processing system in service provider server 180, configure interest identification module 188 to analyze the online activity data for behavioral patterns to generate user interest data indicating an interest of the user and associate the user interest data with the user in the user profile user profile database 196 in storage module 194 to build a user profile, as well as provide any of the other functionality that is discussed herein. Authentication module 190 may be included as a separate module provided in service provider server 180, or may be provided using instructions stored on a computer-readable medium that, when executed by a processing system in service provider server 180, configure authentication module 190 to determine a purchase of an item by user 102 is consistent with the user profile and authenticate user 102 based, at least in part, on the determination, as well as provide any of the other functionality that is discussed herein.

Network interface module 192 is communicatively coupled to network 170, and may be communicatively coupled to any or all of modules 182, 184, 186, 188, and/or 190, any of which may be coupled to a storage module 194. Network interface module 192 may be included as a separate module provided in service provider server 180, or may include communications hardware (e.g., antennas) and instructions stored on a computer-readable medium that, when executed by a processing system in service provider server 180, configure network interface module 192 to operate the communications hardware to send and receive data and/or information over network 170, as well as provide any of the other functionality that is discussed herein.

Storage module 194 may include one or more databases, such as a user profile database 196 containing data relating to online activity and interests in user profiles of one or more users 102, and/or an account database 198 containing account information of one or more users 102 (e.g., personal information, banking information, financial information, funding source information, etc.). The user profile of each user 102 may be associated with account information of each user 102.

Service provider server 180, in one embodiment, may be configured to maintain one or more user accounts and merchant accounts in account database 198 on storage module 194, each of which may include account information associated with one or more individual users (e.g., user 102) and merchants. For example, the account information may include private financial information of user 102 and merchants (e.g., one or more merchants associated with merchant servers 140), such as one or more account numbers, passwords, credit card information, banking information, or other types of financial information, which may be used to facilitate financial transactions between user 102, and one or more merchants associated with merchant servers 140. The account information may also include personal information, such as one or more contact information (e.g., phone number, address, email, etc.) and other account identifications (IDs) of user 102 that are maintained by third parties (e.g., user names or account numbers). In various aspects, the methods and systems described herein may be modified to accommodate users and/or merchants that may or may not be associated with at least one existing user account and/or merchant account, respectively.

In one implementation, user 102 may have identity attributes stored with service provider server 180, and user 102 may have credentials to authenticate or verify identity with service provider server 180. User attributes may include personal information, banking information and/or funding source information. In various aspects, the user attributes may be passed to service provider server 180 as part of a login, search, selection, purchase, and/or payment request, and the user attributes may be utilized by service provider server 180 to associate user 102 with one or more particular user accounts maintained by service provider server 180.

While online activity module 186, interest identification module 188, and authentication module 190 have been illustrated as located in service provider server 180, one of skill in the art will recognize that it may be provided in a separate authentication device without departing from the scope of the present disclosure. The authentication device may include a storage module with a database for user profiles, and/or it may have access to storage module 194 of service provider server 180. While storage module 194 has been illustrated as located in service provider server 180, one of skill in the art will recognize that it may include multiple storage modules and may be connected to other modules through network 170 without departing from the scope of the present disclosure. Other modules discussed herein but not illustrated in FIG. 1 may be provided as separate modules on service provider server 180, or using instructions stored on a computer-readable medium similarly as discussed above.

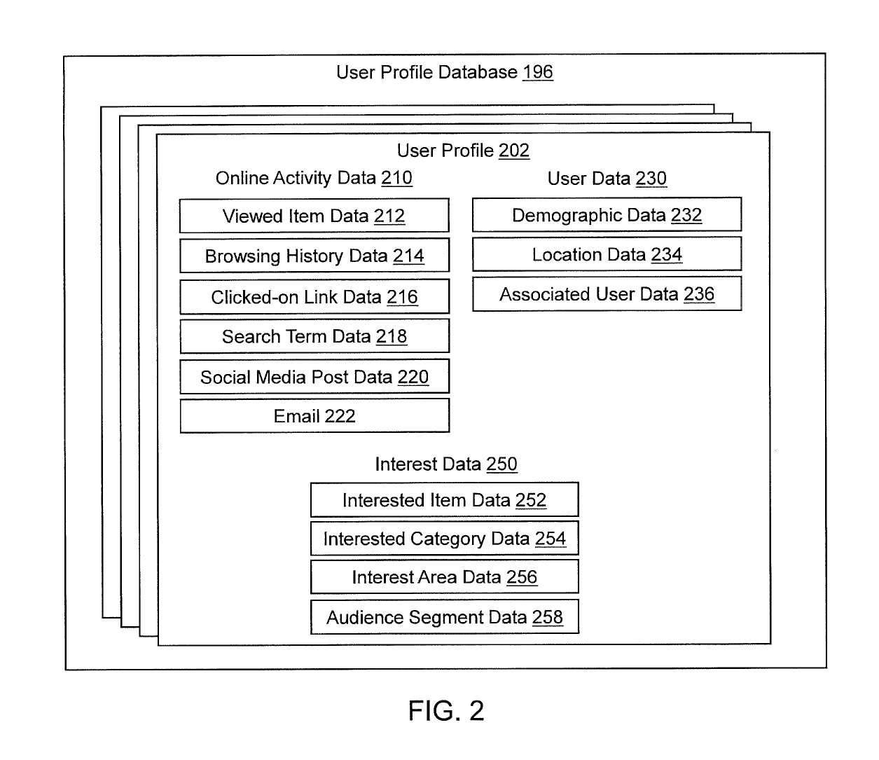

Referring now to FIG. 2, a block diagram for an exemplary user profile database 196 is described according to an embodiment of the present disclosure. User profile database 196 may include one or more user profiles 202 of respective one or more users. Each user profile may be associated with a particular user (e.g., user 102) and may include various data associated with the particular user, such as online activity data 210, user data 230, and/or interest data 250.

Online activity data 210 includes data relating to online activity of user 102, such as viewed item data 212, browsing history data 214, clicked-on link data 216, search term data 218, social media post data 220, and/or email data 222. Online activity module 186 may receive online activity data 210 from user device 120, third-party server 160, and/or independently record online activity data 210 (e.g., for user devices 120 logged in to an account with service provider server 180), and store online activity data 210 in user profile 202.

In an embodiment, user device 120 (e.g., using web browser module 126 and/or browsing activity module 128) may record browsing activity data, such as viewed item data 212, clicked-on link data 214, browsing history, and/or search term data 218. User device 120 may transmit the browsing activity data to service provider server 180. For example, online activity module 186 of service provider server 180 may receive the browsing activity data and associate the browsing activity data with user 102 in user profile 202. In another example, online activity module 186 of service provider server 180 may dynamically sync browsing activity data in user profile 202.

In another embodiment, service provider server 180 may record browsing activity data for browsing activity on user device 120. For example, user 102 may use user device 120 to login to an account with service provider server 180, and allow service provider server 180 to access browsing activity on user device 120. Service provider server 180 (e.g., using online activity module 186) may access browsing activity on user device 120 and record the browsing activity data in user profile 202. In some embodiments, service provider server 180 may use cookies sent to, and stored on, user device 120 to track browsing activity of user 102.

In a further embodiment, third-party server 160 may track browsing activity on user device 120 using one or more cookies sent to, and stored on, user device 120. Service provider server 180 may receive browsing activity data from third-party server 160 along with the one or more cookies that identify web browser module 126 of user device 120.

Viewed item data 212 includes data that indicates user 102 (or another user associated with user 102 such as a parent of user 102) viewed an online representation of an item on a webpage. Viewed item data 212 stored in response to user 102 viewing an online representation of an item on a webpage may include an identity of the item, a type of the item (e.g., a category to which the item belongs), a date and time user 102 viewed a representation of the item, how long user 102 viewed a representation of the item, and/or how many times user 102 viewed a representation of the item.

Browsing history data 214 includes data that indicates webpages that user 102 (or another user associated with user 102 such as a parent of user 102) visited. Browsing history data 214 stored in response to user 102 visiting webpages may include a page title, a date and time user 102 visited a webpage, how long user 102 stayed on a webpage, and/or a number of times user 102 visited a webpage. In an embodiment, online activity module 186 may process browsing history data by determining that a webpage includes a representation of an item to generate viewed item data 212.

Clicked-on link data 216 includes data that indicates links that user 102 (or another user associated with user 102 such as a parent of user 102) clicked on while viewing a website. A link on a website may relate to an item. For example, the link may be a representation of an item that user 102 may click on for more information on the item, a link to retrieve more information on the item (e.g., a “details” link), a zoom-in link to view a larger view of an item, etc. Clicked-on link data 216 stored in response to user 102 clicking on a link relating to an item may include an identity of the item, a type of the item (e.g., a category to which the item belongs), a date and time user 102 clicked on a link relating to the item, and/or a number of times user 102 clicked on a link relating to the item. Clicked-on link data 216 may include data for links that are not related to items, which may be used to determine interests of user 102.

Search term data 218 includes data that indicates search terms (e.g., search query) that user 102 (or another user associated with user 102 such as a parent of user 102) entered on a website. A search term may relate to an item. For example, the search term may be a name of the item, a model number of the item, a category in which the item belongs, a company that manufactures the item, or a term that otherwise identifies the item. Search term data 218 stored in response to user 102 entering a search term include an identity of the item, a type of the item (e.g., a category to which the item belongs), a date and time user 102 searched for the term relating to the item, and/or a number of times user searched using a term relating to the item. Search term data 214 may include data for search terms that are not related to items, which may be used to determine interests of user 102.

Social media post data 220 includes data indicating mentions of an item or an area of interest by user 102 on social media sites, such as social networking sites. In an embodiment, online activity module 186 may scrape a social media account (e.g., an SNS account) of user 102 maintained by third party server 160 to obtain social media post data 220. In another embodiment, third-party server 160 (e.g., using online activity tracking module 164) may scrape a social media account of user 102, which may be maintained by the same or another third-party server 160, and transmit social media post data 220 to service provider server 180.

Email data 222 includes data indicating mentions of an item or an area of interest of user 102 on emails from or to user 102. In an embodiment, online activity module 186 may scrape an email account of user 102 maintained by third party server 160 to obtain email data 222. In another embodiment, third-party server 160 (e.g., using online activity tracking module 164) may scrape an email account of user 102, which may be maintained by the same or another third-party server 160, and transmit email data 222 to service provider server 180.

User data 230 includes data relating to personal information of user 102, such as demographic data 232, location data 234, user relationship data 236, and/or other personal data. Online activity module 186 may receive and store user data 230 from user device 120. User 102 may provide user data 230 to be stored as account information for an account maintained by service provider server 180, for example, as a part of creating the account or updating the account thereafter.

Demographic data 232 may include data indicating gender, age, ethnicity, language, job industry, occupation, or other demographic data. Location data 234 may include residential address, work address, current location, or other location data. The current location may be based on location module 130 of user device 120. Associated user data 236 may include data indicating one or more users associated with user 102. For example, user 102 may be a child and associated users may be parents of user 102. In some embodiments, online activity data 210 of the parents may be used to determine whether user 102 is authorized to make a purchase.

Interest data 250 includes data relating to interests of user 102, such as interested item data 260, interested category data 254, interest area data 256, audience segment data 258, and/or other interest data. Interest identification module 188 of service provider server 180 may process online activity data 210 and/or user data 230 to generate interest data 250. Service provider server 180 may also receive user input indicating interests of user 102 from user device 120.

Interested item data 260 may include data indicating one or more items that user 102 is interested in based on online activity data 210 and/or user data 230. For example, interest identification module 188 may determine that user 102 has shown interest in the one or more items based on user 102 having viewed a representation of the one or more items (e.g., as indicated by viewed item data 212), user 102 having clicked on links relating to the one or more items (e.g., as indicated by clicked-on link data 216) and/or user 102 having searched for the one or more items (e.g., as indicated by search term data 216). In another example, interested identification module 188 may determine that user 102 has shown interest in the one or more items based on user 102 placing the one or more items in a wish-list or in a shopping cart. In a further example, interest identification module 188 may determine that user 102 has shown interest in the one or more items based on a number of times user 102 showed interest in the one or more items or how recently user 102 showed interest in the one or more items. Interest identification module 188 may also determine a level of interest based on the online activity data 210 (e.g., a number of times user 102 showed interest in the one or more items or how recently user 102 showed interest in the one or more items). Interest identification module 188 may store the identities of the one or more items that user 102 is interested in as interested item data 252 in user profile 202.

Interested category data 254 may include data indicating categories of items, such as an item type, that user 102 is interested in based on online activity data 210, user data 230, and/or interest data 250. The category may range from general/broad to specific/narrow. For example, interested item data 252 may indicate that user 102 is interested in a specific item (e.g., a single-lens reflex (SLR) camera of a specific model number). Interested category data 254 may indicate user 102 is interested in another item having an item type of the specific item, which may be range from narrow (e.g., SLR cameras made by the same company, or SLR cameras of similar specification made by different companies) to broad (e.g., any cameras, or any image capture devices).

In an embodiment, interest identification module 188 may determine a category or item type, including how broad an interest of user 102 is, based on online activity data 210. For example, if user 102 viewed representations of items of similar specification made by various manufacturers (e.g., SLR cameras of similar specification from various manufacturers), interest identification module 188 may determine user 102 is interested in a type of item having such specification. In another example, if user 102 viewed representation of items varying in specification but from one manufacturer (e.g., cameras made by one manufacturer), interest identification module 188 may determine user 102 is interested in a type of item from specific manufacturer. In a further example, if user 102 viewed representation of two or more items (e.g., a camera and a video recorder) that belong to the same broad category, interest identification module 188 may determine user 102 is interested in a type of item having a broad scope (e.g., image capture device). In further embodiments, interest identification module 188 may determine a category or item type further based on user data 230 and/or interest data 250.

Interest area data 256 may include data indicating interest areas (e.g., hobbies, activities, or other interests) based on online activity data 210, user data 230, and/or interest data 250. In an embodiment, interested item data 252 may indicate that user 102 is interested in a hobby (e.g., winter sports) based on user 102 having viewed a representation of items that relate to the hobby (e.g., skis and a ski jacket).

Audience segment data 258 may include data indicating one or more audience segment that user 102 is a part of based on online activity data 210, user data 230, and/or interest data 250. In an embodiment, interest identification module 188 may determine an audience segment in which user 102 belongs based on, for example, demographic data 232 and interest data 250, and determine what members of the audience segment are interested in, such as items that members are interested in, item categories or item types that members are interested in, and/or interest areas of members.

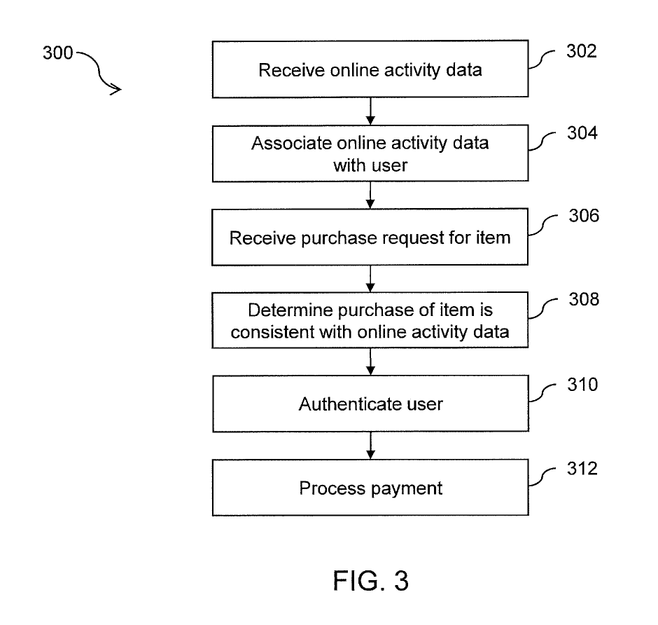

Referring now to FIG. 3, a flowchart 300 of a method for authentication using online activity is illustrated according to an embodiment of the present disclosure.

At block 302, service provider server 180 receives online activity data, such as online activity data 210. In an embodiment, service provider server 180 (e.g., using online activity module 186) may receive browsing activity data, such as viewed item data 212, browsing history data 214, clicked-on link data 216, and/or search term data 218, from user device 120 (e.g., using web browser module 126 and/or browsing activity module 128). For example, service provider server 180 may receive browsing activity data recorded by web browser module 126 and/or browsing activity module 128 of user device 120. In another example, service provider server 180 may receive browsing activity data by accessing and recording browsing activity on web browser module 126 of user device 120.

In another embodiment, service provider server 180 (e.g., using online activity module 186) may receive browsing activity data using cookies, and/or receive browsing activity data obtained by third-party server 160 using tracking cookies. For example, service provider server 180 and/or third-party server 160 may transmit and store one or more tracking cookies on user device 120. In response to user 102 visiting a website associated with or affiliated with service provider server 180 and/or third-party server 160, user device 120 may send the one or more tracking cookies to service provider server 180 and/or third-party server 160. Accordingly, service provider server 180 and/or third-party server 160 may track browsing activity of user 102 each time user 102 visits a website associated with or affiliated with service provider server 180 or third-party server 160.

In another embodiment, service provider server 180 (e.g., using online activity module 186) may receive social media post data 220 and/or email data 222 from third-party server 160. For example, service provider server 180 may receive social media post data 220 and/or email data 222 by scraping a social networking account or email account of user 102 on third-party server 160. In another example, service provider server 180 may receive social media post data 220 and/or email data 222 scraped by third-party server 160.

At block 304, service provider server 180 associates online activity data 210 with user 102 in storage module 194. In an embodiment, service provider server 180 (e.g., using online activity module 186) may associate online activity data 210 with user 102 in user profile database 196 on storage module 194 in response to receiving online activity data 210.

At block 306, service provider server 180 receives a purchase request for an item. In an embodiment, user 102 may use user device 120 to purchase an item from a merchant. Alternatively, user 102 at a physical merchant location may take an item to a point of sale (POS) of the merchant to purchase the item. Merchant server 140 associated with the merchant may generate a payment request for the purchase of the item and transmit the payment request to service provider server 180.

At block 308, service provider server 180 determines whether purchase of the item by user 102 is consistent with online activity data 210. In various embodiments, service provider server 180 (e.g., using authentication module 190) may access online activity data 210 associated with user 102 to determine whether purchase of the item by user 102 is consistent with online activity data 210.

In an embodiment, service provider server 180 (e.g., using authentication module 190) may determine the purchase is consistent with online activity data 210 based, at least in part, on viewed item data 212 indicating user 102 viewed an online representation of the item or another item having the same item type or belonging to the same category, multiple times on one or more webpages. In another embodiment, service provider server 180 (e.g., using authentication module 190) may determine the purchase is consistent with online activity data 210 based, at least in part, on online activity data 210 indicating one or more online actions (e.g., clicking on a link relating to the item, searching for the item, viewing a representation of the item on a website, etc.) by user 102 directed to an online representation of the item or another item having the same item type or belonging to the same category.

In certain embodiments, service provider server 180 may give more weight to a recently received part of the online activity data and give less weight or ignore a part of the online activity data received before a predetermined time period.

In a further embodiment, service provider server 180 (e.g., using authentication module 190) may determine the purchase is consistent with online activity data 210 by determining that another user authorized user 102 to make the purchase based, at least in part, on online activity data 210 of the other user. For example, user 102 may be a child, and service provider server 180 may determine that the purchase is consistent with online activity data 210 by determining a parent of user 102 (e.g., a parent has viewed the item) authorized the purchase of the item by determining that the parent viewed an online representation of the item.

In some embodiments, service provider server 180 (e.g., using authentication module 190) may generate a consistency score based on the determination of whether the purchase is consistent with online activity data 210.

At block 310, service provider server 180 authenticates user 102 based, at least in part, on the determination that the purchase of the item by user 102 is consistent with online activity data 210. In an embodiment, service provider server 180 (e.g., using authentication module 190) may authenticate user 102 based on the determination that the purchase is consistent with online activity data 210 and on other authentication techniques. For example, service provider server 180 (e.g., using authentication module 190) may receive credentials of user 102 that includes, for example, a user identifier (ID) (e.g., a username, an email address, a phone number, etc.) and a password. Service provider server 180 may authenticate user 102 based on the credentials and on the determination that the purchase is consistent with online activity data 210. In other embodiments, service provider server 180 may authenticate user 102 based on the determination that the purchase is consistent with online activity data 210 without other authentication techniques or with reduced authentication, such as taking and sending a photo of user 102. In some embodiments, service provider server 180 may request additional authentication information, and the amount of the requested information may depend on the level of consistency of the purchase with online activity data 210, such as the consistency score, and/or information associated with the purchase request, such as price, type of item(s), location, time, and merchant.

At block 312, service provider server 180 processes the payment request. In an embodiment, service provider server (e.g., using payment processing module 184) may process the payment request in response to authenticating user 102.

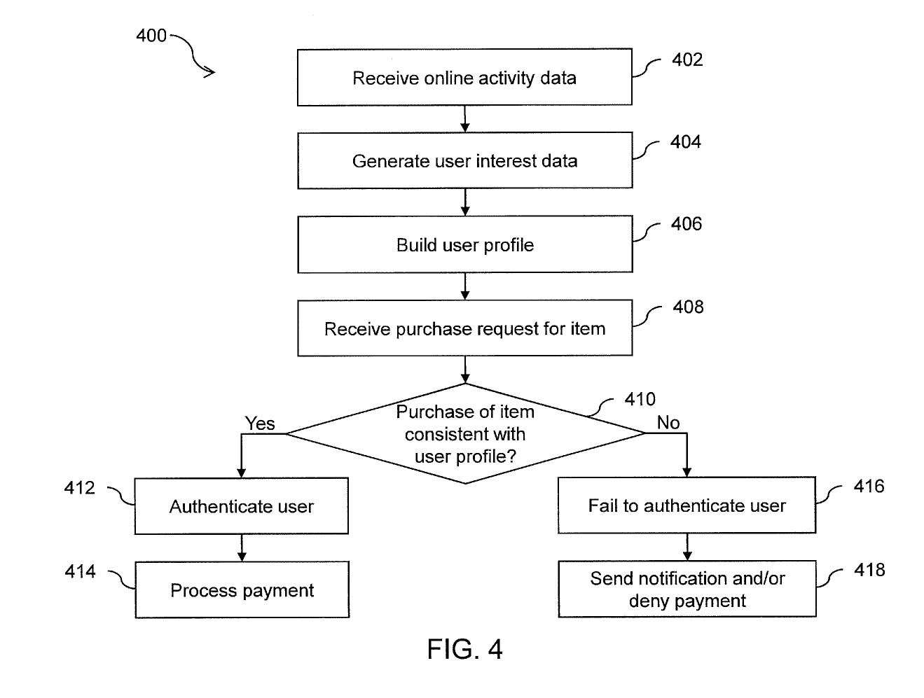

Referring now to FIG. 4, a flowchart 400 of a method for method for authentication using a user profile is illustrated according to an embodiment of the present disclosure.

At block 402, service provider server 180 receives online activity data, such as online activity data 210, as described at block 302 of FIG. 3.

At block 404, service provider server 180 generates user interest data, such as interest data 230. In an embodiment, service provider server 180 (e.g., using interest identification module 188) may generate user interest data 230 including interested item data 252, interested category data 254, interest area data 256, and/or audience segment data 258.

At block 406, service provider server 180 builds a user profile, such as user profile 202. In an embodiment, service provider server 180 (e.g., using online activity module 186 and/or interest identification module 188) may associate online activity data 210 and/or interest data 250 with user 102 in user profile 202 of user profile database 196 on storage module 194. Service provider server 180 may also receive user data 230 from user device 120 or access user data 230 from a user account stored in account database 198 of storage module 194, and associate user data 230 with user 102 in user profile 202.

At block 408, service provider server 180 receives a purchase request for an item, as described at block 306 of FIG. 3.

At block 410, service provider server 180 determines whether purchase of the item by user 102 is consistent with user profile 202 that includes online activity data 210, user data 230, and/or user interest data 250. In various embodiments, service provider server 180 (e.g., using authentication module 190) may access user profile 202 associated with user 102 to determine whether purchase of the item by user 102 is consistent with user profile 202.

In an embodiment, service provider server 180 (e.g., using authentication module 190) may determine the purchase is consistent with online activity data 210 (as described at block 308 in FIG. 3) and interest data 230. Service provider server 180 may determine the purchase is consistent with interest data 230 based, at least in part, on whether the item relates to an interest of user 102 as indicated by interest data 230.

In some embodiments, service provider server 180 (e.g., using authentication module 190) may generate a consistency score based on the determination of whether the purchase is consistent with user profile 202.

At block 412, service provider server 180 authenticates user 102 based, at least in part, on the determination that the purchase of the item by user 102 is consistent with user profile 202. In an embodiment, service provider server 180 (e.g., using authentication module 190) may authenticate user 102 based on the determination that the purchase is consistent with user profile 202 and on other authentication techniques. For example, service provider server 180 may receive credentials of user 102 that includes, for example, a user ID (e.g., a username, an email address, a phone number, etc.) and a password. Service provider server 180 may authenticate user 102 based on the credentials and on the determination that the purchase is consistent with user profile 202. In other embodiments, service provider server 180 may authenticate user 102 based on the determination that the purchase is consistent with user profile 202 without other authentication techniques. In some embodiments, service provider server 180 may request additional authentication information, and the amount of the requested information may depend on the level of consistency of the purchase with user profile 202, such as the consistency score.

At block 414, service provider server 180 processes the payment request by approving the payment request. In an embodiment, service provider server (e.g., using payment processing module 184) may process the payment request in response to authenticating user 102.

At block 416, service provider server 180 fails to authenticate user 102 based, at least in part, on the determination that the purchase of the item by user 102 is not consistent with user profile 202. In an embodiment, service provider server 180 (e.g., using authentication module 190) may determine that the purchase of the item is not consistent with online activity data 210 and/or interest data 250.

At block 418, service provider server 180 sends a notification or a request for additional authenticating information to user device 120. Service provider server 180 may also processes the purchase request by denying the payment request.

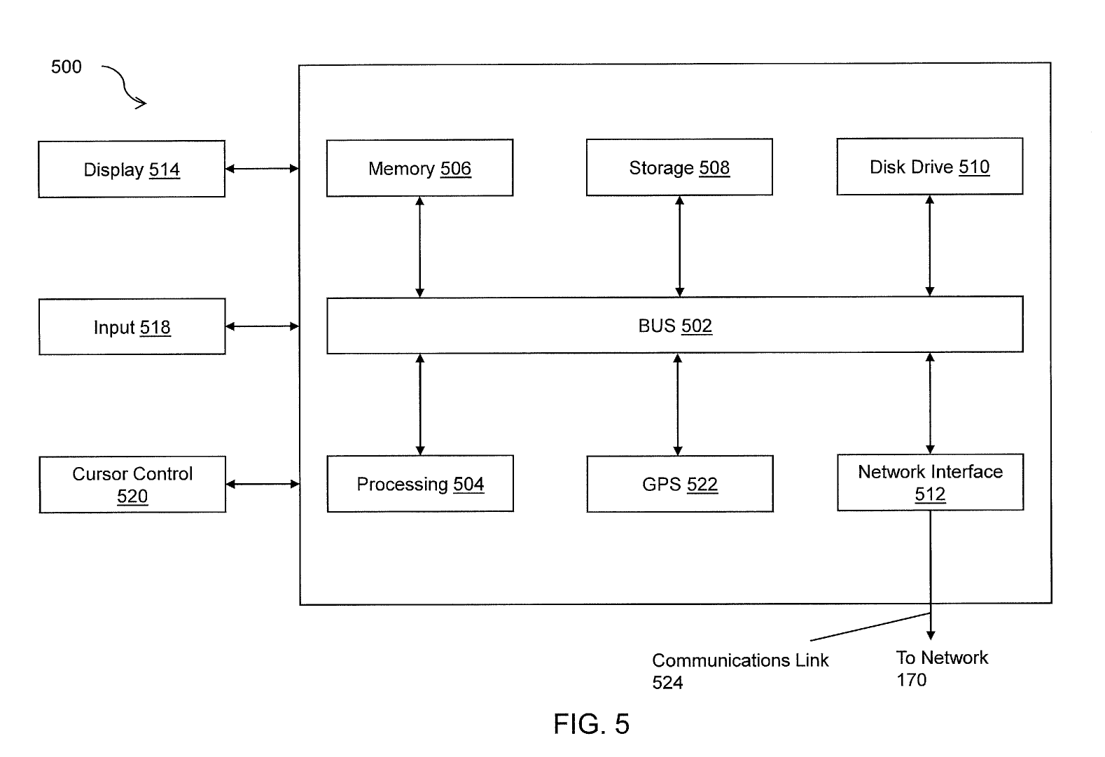

Referring now to FIG. 5, an embodiment of a computer system 500 suitable for implementing, for example, the user device, merchant server, third-party server, and service provider server is illustrated. It should be appreciated that other devices utilized by users, service providers, and/or merchants in the system discussed above may be implemented as computer system 500 in a manner as follows.

In accordance with various embodiments of the present disclosure, computer system 500, such as a computer and/or a network server, includes a bus 502 or other communication mechanism for communicating information, which interconnects subsystems and components, such as a processing component 504 (e.g., processor, micro-controller, digital signal processor (DSP), etc.), a system memory component 506 (e.g., RAM), a static storage component 508 (e.g., ROM), a disk drive component 510 (e.g., magnetic or optical), a network interface component 512 (e.g., modem or Ethernet card), a display component 514 (e.g., light-emitting diode (LED) display component, organic light-emitting diode (OLED) component, liquid-crystal (LCD) display component, plasma display panel (PDP), cathode ray tube (CRT) display component, or other display component), an input component 518 (e.g., keyboard, keypad, virtual keyboard, touchscreen, etc.), a cursor control component 520 (e.g., mouse, pointer, trackball, etc.), and/or a location determination component 522 (e.g., a Global Positioning System (GPS) device as illustrated, a cell tower triangulation device, and/or a variety of other location determination devices known in the art). In one implementation, disk drive component 510 may include a database having one or more disk drive components.

In accordance with various embodiments of the present disclosure, computer system 500 performs specific operations by processor 504 executing one or more sequences of instructions contained in memory component 506, such as described herein with respect to the user device, merchant server, third-party server, and service provider server. Such instructions may be read into system memory component 506 from another computer readable medium, such as static storage component 508 or disk drive component 510. In other embodiments, hard-wired circuitry may be used in place of, or in combination with, software instructions to implement the present disclosure.

Logic may be encoded in a computer readable medium, which may refer to any medium that participates in providing instructions to processor 504 for execution. Such a medium may take many forms, including but not limited to, non-volatile media, volatile media, and transmission media. In one embodiment, the computer readable medium is non-transitory. In various implementations, non-volatile media includes optical or magnetic disks, such as disk drive component 510, volatile media includes dynamic memory, such as system memory component 506, and transmission media includes coaxial cables, copper wire, and fiber optics, including wires that comprise bus 502. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by a communication link 524 to the network 170 (e.g., such as a LAN, WLAN, PTSN, and/or various other wired or wireless networks, including telecommunications, mobile, and cellular phone networks) may perform instruction sequences to practice the present disclosure in coordination with one another.

Computer system 500 may transmit and receive messages, data, information and instructions, including one or more programs (i.e., application code) through communication link 524 and network interface component 512. Network interface component 512 may include an antenna, either separate or integrated, to enable transmission and reception via communication link 524. Received program code may be executed by processor 504 as received and/or stored in disk drive component 510 or some other non-volatile storage component for execution.

In view of the present disclosure, it will be appreciated that various devices, systems, and methods have been described according to one or more embodiments for authentication using online activity.

Although various components and steps have been described herein as being associated with user device 120, merchant server 140, third-party server 160, and service provider server 180 of FIG. 1, it is contemplated that the various aspects of such devices and servers illustrated in FIG. 1 may be distributed among a plurality of servers, devices, and/or other entities.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, mobile device, server, and other devices described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a storage module configured to store a user profile of a user, the user profile including online activity data;
an authentication module configured to determine a purchase of an item by the user is consistent with the user profile in response to receiving a payment request for the purchase of the item using an account associated with the user, and authenticate the user based, at least in part, on the determination; and
a payment processor module configured to process the payment request in response to authenticating the user.

2. The system of claim 1, wherein the an authentication module is configured to receive credentials of the user including a user identifier (ID) and a password, and authenticate the user based, at least in part, on the credentials.

3. The system of claim 1, wherein the online activity data comprises viewed item data, and wherein the authentication module is configured to determine the purchase is consistent with the user profile based, at least in part, on the viewed item data indicating the user viewed an online representation of the item or another item having an item type of the item a plurality of times.

4. The system of claim 3, wherein the online activity data further comprises clicked-on link data, visited webpage data, and/or search term data, and wherein the authentication module is configured to determine the purchase is consistent with the user profile based, at least in part, on the online activity data indicating the user performed an action directed to the online representation of the item or the other item having the item type of the item.

5. The system of claim 4, wherein the authentication module is configured to give more weight to a recent part of the online activity data.

6. The system of claim 1, wherein the online activity data comprises viewed item data, and wherein the authentication module is configured to determine the purchase is consistent with the user profile based, at least in part, on the viewed item data indicating another user associated with the user viewed an online representation of the item or another item having an item type of the item.

7. The system of claim 1, wherein the online activity data comprises social media post data obtained by scraping a social media account of the user or email data obtained by scraping an email account of the user, and wherein the authentication module is configured to determine the purchase is consistent with the user profile based, at least in part, on the social media post data or the email data indicating the user mentioned the item or another item having an item type of the item.

8. The system of claim 1, wherein the user profile further includes user interest data indicating an interest of the user, and wherein the authentication module is configured to determine the purchase is consistent with the user profile based, at least in part, on whether the item relates to the interest.

9. The system of claim 8, further comprising:
an online activity module configured to associate the online activity data with the user in the user profile in response to receiving the online activity data; and
an interest identification module configured to analyze the online activity data for behavioral patterns to generate the user interest data and associate the user interest data with the user in the user profile.

10. The system of claim 9, wherein the interest identification module is further configured to determine an audience segment in which the user belongs based on the online activity data, and wherein the authentication module is configured to determine the purchase is consistent with the user profile based, at least in part, on a proportion of the audience segment that is interested in the item or another item having an item type of the item.

11. A method comprising:
receiving, by a processing system over a network through a network interface from a user device, online activity data of a user;
associating, by the processing system in response to the receiving, the online activity data with the user in a non-transitory hardware memory;
receiving, by the processing system, a payment request for a purchase of an item using an account associated with the user;
determining, by the processing system, the purchase of the item by the user is consistent with the online activity data;
authenticating, by the processing system, the user based, at least in part, on the determining; and
processing, by the processing system, the payment request based on the authenticating.

12. The method of claim 11, further comprising receiving, by the processing system over the network through the network interface from the user device, credentials of the user including a user ID and a password, wherein the authenticating is based, at least in part, on the credentials.

13. The method of claim 11, wherein the online activity data comprises viewed item data, and wherein the authenticating is based, at least in part, on the viewed item data indicating the user viewed an online representation of the item or another item having an item type of the item a predetermined number of times.

14. The method of claim 13, wherein the online activity data comprises clicked-on link data, visited webpage data, and search term data, and wherein the authenticating is based, at least in part, on the online activity data indicating the user performed an action directed to the online representation of the item or the other item having the item type of the item.

15. The method of claim 14, wherein the authenticating comprises giving less weight to or ignoring a part of the online activity data from before a predetermined time period.

16. The method of claim 11, wherein the online activity data comprises social media data or email data, the method further comprising scraping a social media account of the user or an email account of the user to obtain the social media data or the email data, and wherein the authenticating is based, at least in part, on the social media post data or the email data indicating the user mentioned the item or another item having an item type of the item.

17. The method of claim 11, further comprising:
analyzing, by the processing system, the online activity data for behavioral patterns;
generating, by the processing system in response to the analyzing, user interest data indicating an interest of the user; and
associating, by the processing system in response to the generating, the user interest data with the user in the non-transitory hardware memory,
wherein the determining is based, at least in part, on whether the item relates to the interest.

18. The method of claim 17, wherein the generating comprises determining an audience segment in which the user belongs based on the online activity data, and wherein the determining is based, at least in part, on whether the item relates to an interest of members of the audience segment.

19. A non-transitory machine-readable medium comprising a plurality of machine-readable instructions which, when executed by one or more processors, causes the one or more processors to perform a method comprising:
associating online activity data with a user in a non-transitory hardware memory in response to receiving the online activity data from a user device;
determining whether a purchase of an item by the user is consistent with the online activity data in response to receiving a payment request for the purchase of the item using an account associated with the user;
deciding whether to authenticate the user based, at least in part, on the determining; and
processing the payment request by approving the payment request in response to authenticating the user or denying the payment request in response to failing to authenticate the user.

20. The non-transitory machine-readable medium of claim 19, the method further comprising transmitting a notification and/or a request for additional authenticating information in response to determining the purchase of the item is not consistent with the online activity data.
